(19) United States
(12) Patent Application Publication
(10) Pub. No.: US 2015/0228095 A1
(43) Pub. Date: Aug. 13, 2015

(54) Method and apparatus for generating a heatmap

(71) Applicant: QUALCOMM Incorporated, San Diego, CA (US)

(72) Inventors: Yin CHEN, Campbell, CA (US); Jiajian Chen, San Jose, CA (US); Hui Chao, San Jose, CA (US); Payam Pakzad, Mountain View, CA (US)

(73) Assignee: QUALCOMM Incorporated, San Diego, CA (US)

(21) Appl. No.: 14/177,990

(22) Filed: Feb. 11, 2014

(51) Int. Cl. G06T 11/20

(52) U.S. Cl. CPC G06T 11/206

(57) ABSTRACT

Systems, apparatus and methods for generating a heatmap are presented. A first floor plan is received. A device detects stair lines in the first floor plan and reduces the stair lines from the first floor plan to form a second floor plan. A heatmap is generated based on the second floor plan. The device includes a transceiver to receive the first floor plan and a processor, coupled to the transceiver, to detect stair lines in the first floor plan, reduce the stair lines in the first floor plan to form a second floor plan, and generate the heatmap from the second floor plan.

### BACKGROUND

I. Field of the Invention

This disclosure relates generally to systems, apparatus and methods for generating propagation models, and more particularly to replacing stair lines from an indoor 2-dimensional (2-D) map with no stair lines, one stair line, two stair lines, or just a few stair lines prior to generate a heatmap.

II. Background

WiFi signal propagation modeling is used for many indoor positioning algorithms. A WiFi heatmap is estimated based on locations of access point (AP) and an indoor map of a floor. An indoor map shows walls, doorways, hallways, stairs and other features and represents each 3-dimensional (3-D) feature with one or more 2-D lines. A particular line on the indoor map is often interpreted as a wall providing a certain level of signal attenuation. This signal attenuation is accounted for when generating a heatmap for signals generated by APs. Indoor maps do not distinguish between walls and stairs. Stairs, which are often drawn as a number of parallel lines, unfortunately are interpreted as a number of parallel walls causing a signal to attenuate more than appropriate on a heatmap with each step. Presently, using a 2-D indoor map, without distinguishing walls and stairs, may cause an estimation and generation of an inaccurate heatmap.

Therefore, what is needed is to properly interpret stairs with a correct amount of attenuation, which will lead to a more accurate heatmap.

### BRIEF SUMMARY

Disclosed are systems, apparatus and methods for generating a heatmap.

According to some aspects, disclosed is a method in a device for generating a heatmap, the method comprising: receiving a first floor plan; detecting stair lines in the first floor plan; reducing the stair lines from the first floor plan to form a second floor plan; and generating the heatmap based on the second floor plan.

According to some aspects, disclosed is a device for generating a heatmap, the device comprising: a transceiver configured to receive a first floor plan; and a processor coupled to the transceiver, wherein the processor is configured to: detect stair lines in the first floor plan; reduce the stair lines in the first floor plan to form a second floor plan; and generate the heatmap from the second floor plan.

According to some aspects, disclosed is a device for generating a heatmap, the device comprising: means for receiving a first floor plan; means for detecting stair lines in the first floor plan; means for reducing the stair lines from the first floor plan to form a second floor plan; and means for generating the heatmap based on the second floor plan.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIG. 1 shows a top-down view of a staircase.

FIGS. 2A and 2B show attenuation associated with a mobile device and an access point separated by stairs where the stairs are interpreted as walls.

FIGS. 3, 4, 5 and 6 illustrate reducing a number of stairs lines on a floor plan, in accordance with some embodiments.

FIGS. 7, 8 and 9 show an actual route and estimated tracks through a floor plan, in accordance with some embodiments.

FIG. 10 shows a device for preparing a heatmap, in accordance with some embodiments.

FIG. 11 illustrates a method for preparing a heatmap, in accordance with some embodiments.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

As used herein, a mobile device, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

Systems, apparatus and methods for generating a heatmap are presented. A floor plan often shows steps of a staircase or stairwell as parallel lines. Such a floor plan may be used to generate a heatmap but each step is unfortunately interpreted as one of several parallel walls. Examples here replace these parallel lines representing stairs with zero, one or two lines prior to generating a heatmap. Descending stairs present no obstructions between an access point and a mobile device. Therefore, a descending staircase may be replaced on a floor plan with an open space. Ascending stairs present few walls worth of attenuation and therefore may be replaced on a floor plan with one to three parallel lines. Such an altered floor plan may then be using to generate a more accurate heatmap.

Some embodiments interpret stairs with a lower amount of attenuation, which leads to a more accurate heatmap. As a result of having a more accurate heatmap, nearby walks, entries to and exits from stairs are more accurately determined, therefore, a user changing floors or walking by a staircase is more accurately tracked. When a user enters a stairwell or other floor changing portal, the mobile device uses a different map for that new floor. Therefore, areas around those regions are highly important for a smooth user experience. By more accurately determining a portal transition, the mobile device uses the correct heatmap with a corresponding listing of access points.

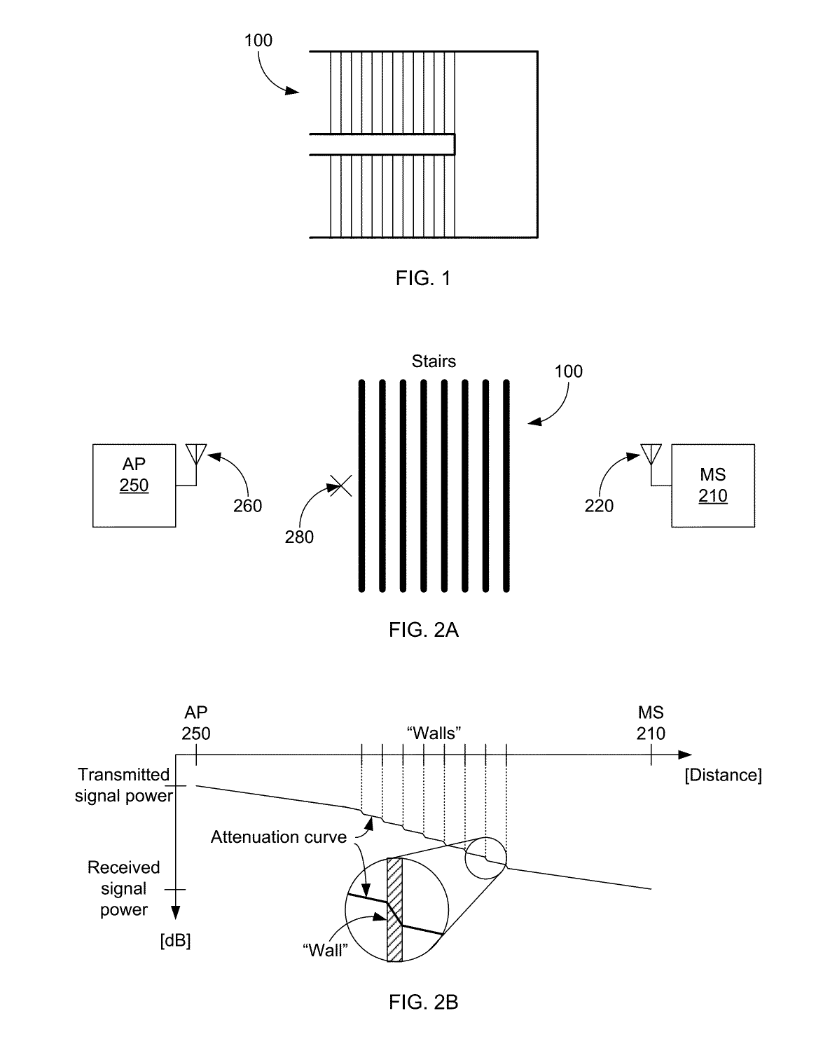

FIG. 1 shows a top-down view of a staircase 100. The staircase 100 shown in a 2-D representation of a three dimensional surface. To most heatmap algorithms, the staircase 100 is depicted as a number of parallel lines and therefore interpreted as a number of parallel walls. Step lines are shown parallel in this example but may actually be from a spiral staircase or other non-parallel stair case. When generating a heatmap, a simulator attenuates any signal travelling through a wall by a certain amount. This amount is repeated, in the case of misinterpreted stairs, for each step. That is, when interpreted as a number of parallel walls, a simulated signal is greatly attenuated more than stairs alone would otherwise attenuate the signal.

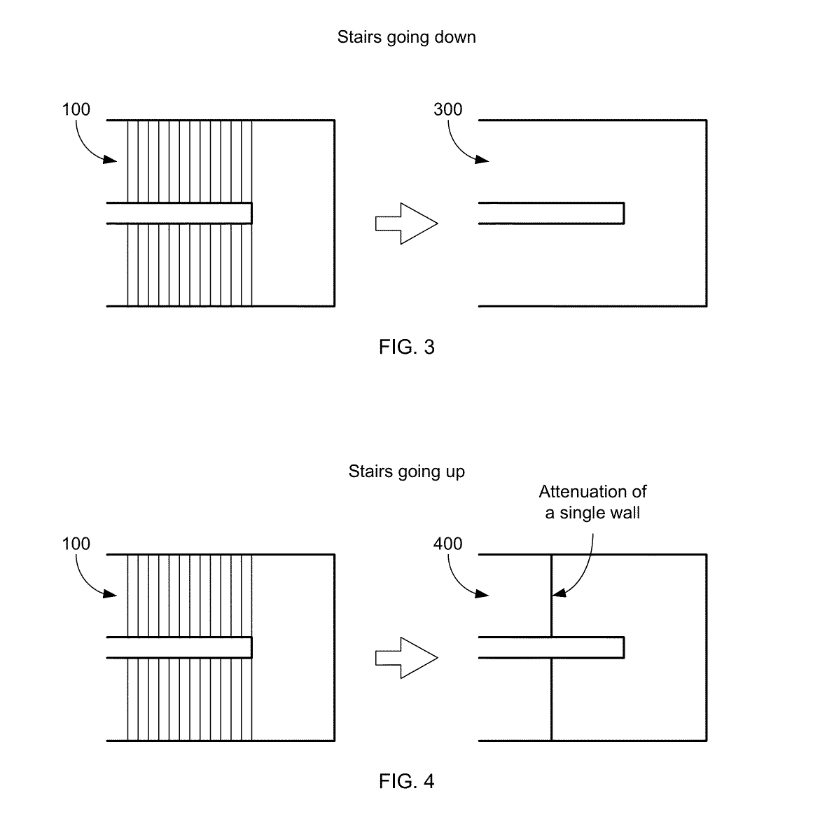

FIGS. 2A and 2B show attenuation associated with a mobile device 210 and an access point 250 separated by a staircase 100 where the stairs are interpreted as walls. In FIG. 2A, a mobile device 210 is shown separated by a staircase 100 (having several parallel steps) from an access point 250. The antenna of the mobile device 210 is at position 220 and the antenna of the access point 250 is at position 260. If the stairs are descending to a lower floor, the mobile device 210 may actually communicate signals with the access point 250 with no objects attenuating the signal between the access point 250 and the mobile device 210. If the stairs are ascending to a higher floor, the mobile device 210 may communicate with the access point 250 through a single wall, two walls or three walls.

In practice in the prior art, the staircase 100 is seen as a large number of parallel lines and interpreted as a large number of parallel walls. As a result, a heatmap interprets an otherwise strong signal from an access point 250 (e.g., a signal that passed through no walls or just one wall) as the mobile device 210 being positioned closer the access point 250 than is actually located. For example, a mobile device 210 with an antenna at position 220 and an access point 250 at position 260 appears “pulled” towards the access point 250 and on the opposite side to the staircase 100 at position 280.

In FIG. 2B, an attenuation curve for a signal from the access point 250 to the mobile device 210 in FIG. 2A is shown. With a linear distance scale, the attenuation curve drops off logarithmically as the distance increases between the mobile device 210 and the access point 250. With a logarithmic distance scale, the attenuation curve drops off linearly as the distance between the mobile device 210 and the access point 250 increases. In other words, the path loss is proportional to a log of the distance, or L∝ log₁₀(d), where L is path loss and d is distance. Independently of how depicted, a signal encounters a low level of attenuation for open space, a medium level of attenuation for a staircase 100, and significant or a high level of attenuation for each wall. In this case, each parallel line is interpreted as a parallel wall providing significant signal attention whereas the open space before, between and after the steps provides little attenuation. When several steps are interpreted as walls, a signal is simulated as beginning at a transmitter (at a particular transmitted power level), attenuated by the several walls and open space, and then received at a receiver with a lower received signal power level. Because of the several simulated walls, the model predicts significantly less power is received than is actual received. Therefore, the predicted model tends to “pull” the mobile device 210 closer to the access point 250 and on the wrong side of the staircase 100.

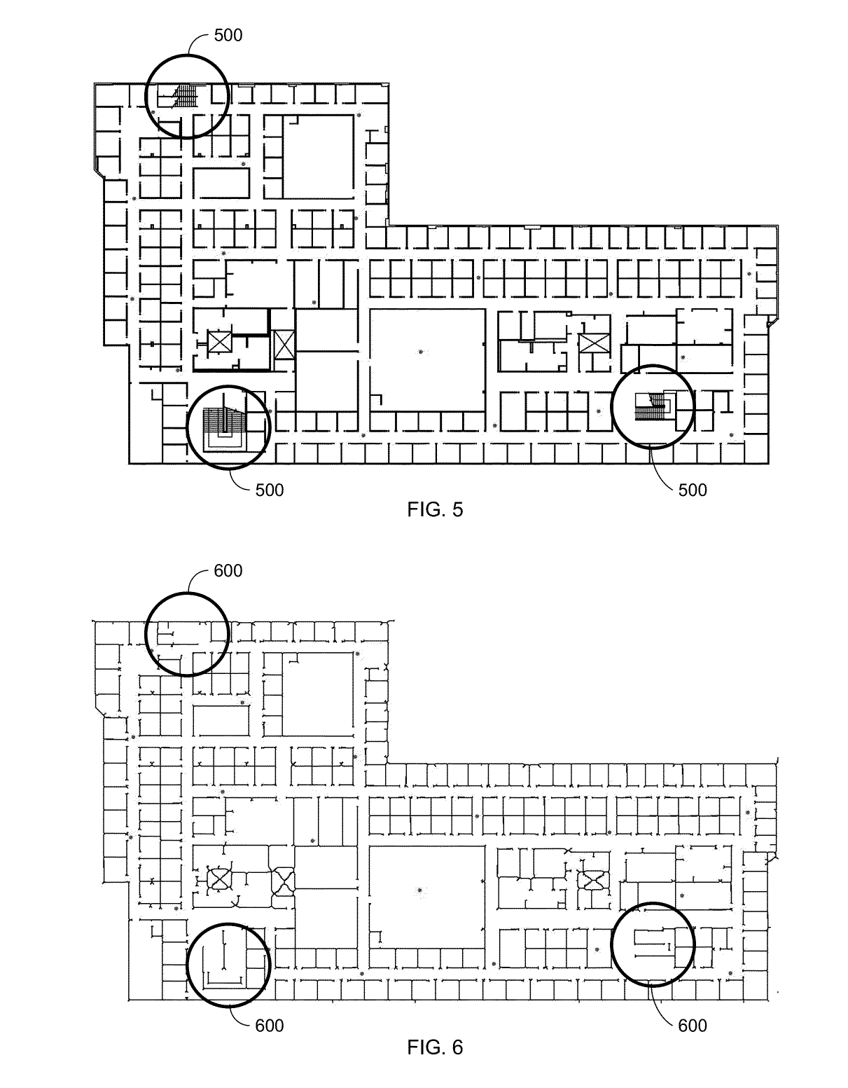

FIGS. 3, 4, 5 and 6 illustrate reducing of number of stairs lines on a floor plan, in accordance with some embodiments. A floor plan is sometimes referred to as a floor map and is a 2-D representation of a 3-D space. In the following text, a floor plan with stair lines is referred to as a first floor plan or floor plan A. A floor plan with reduced or eliminated stair lines is referred to as a second floor plan or floor plan B.

In FIG. 3, staircase 100 from a first floor plan (floor plan A) is replaced with no steps or an open space 300 in a second floor plan (floor plan B). In this case, the staircase 100 is going down to a lower level and thus provides no actual attenuation. The altered floor plan (also referred to as the second floor plan) with open space 300 may be used to generate a heatmap that more accurately provides little or no attenuation due to the staircase 100.

In FIG. 4, the staircase 100 from a first floor plan is replaced with a single step 400 or a single wall in a second floor plan. In this case, the staircase 100 is going up to a higher level and thus provides only some attenuation. Alternatively, a staircase 100 may be replaced with two lines to provide two walls worth of attenuation in a subsequent heatmap. Alternatively, a staircase 100 may be replaced with three walls worth of attenuation. Again, the altered floor plan may be used to generate a heatmap that more accurately provides only some attenuation due to the staircase 100.

In FIG. 5, an unaltered floor plan (a first floor plan) is shown of a top floor depicting three areas, each referred to as area 500. Each area 500 shows a staircase 100 going down to a lower floor. A heatmap generated directly from this unaltered floor plan tends to “pull” a mobile device 210 closer to an access point 250 and on the opposite side of a staircase 100 than actually positioned. In FIG. 6, the staircase 100 in each area 500 has been replaced with an area 600 without stairs. A heatmap generated from this altered floor plan (a second floor plan) results in a more accurate heatmap.

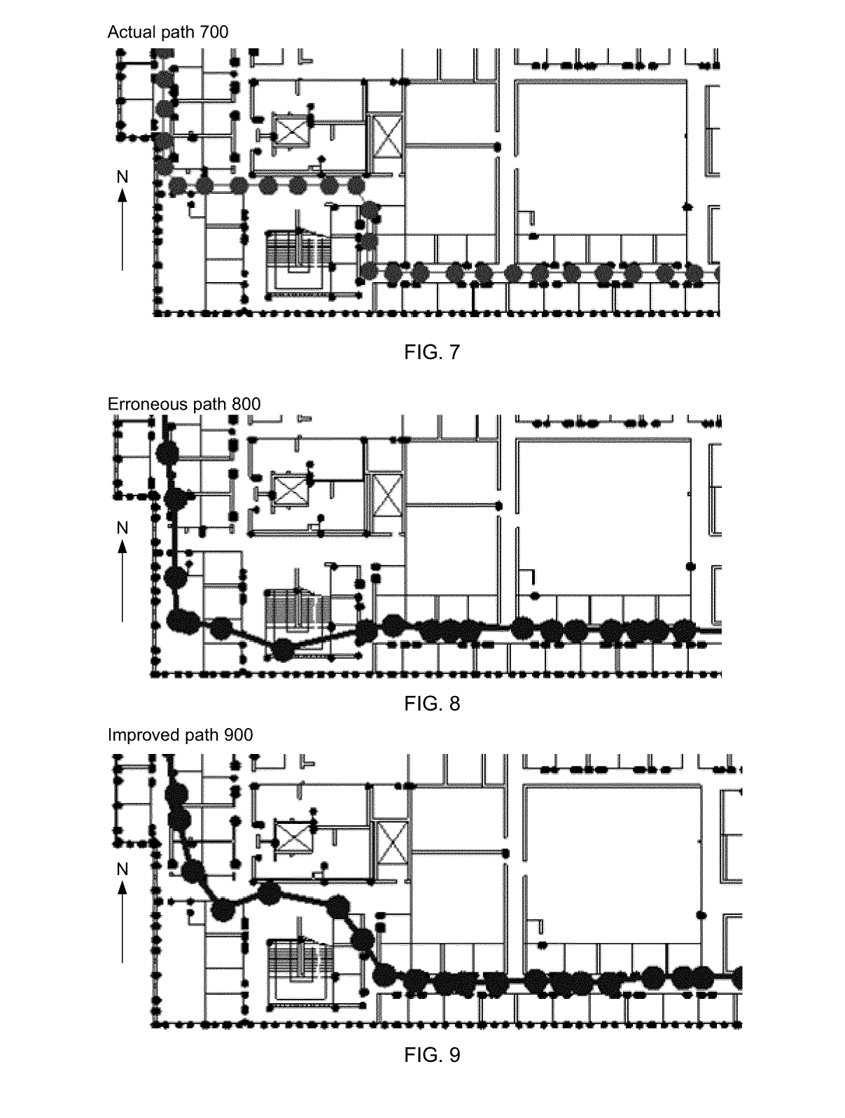

FIGS. 7, 8 and 9 show an actual route and estimated tracks through a floor plan, in accordance with some embodiments. The floor plan includes a staircase 100 going down. In FIG. 7, a true or an actual path 700 is shown on the floor plan that starts at the top left and finishes at the bottom right. A mobile device 210 first travels with a user south and then east followed by traveling south and east again.

In FIG. 8, a mobile device 210 uses a heatmap generated from an unaltered floor plan (a first floor plan) interpreting stairs as several parallel walls. The erroneous path 800 of the mobile device 210 is computed as traveling directly south and then east through several office walls. The mobile device 210 is shown traversing around a staircase 100 on an opposite side than actually traveled.

In FIG. 9, a mobile device 210 uses a heatmap generated from an altered floor plan (a second floor plan). The heatmap interprets several parallel lines as a staircase 100 with no wall attenuation. The second heatmap is used to more accurately estimate an improved path 900 of the mobile device 210. The improved path 900 mobile device 210 more closely follows the actual path 700 than does the erroneous path 800.

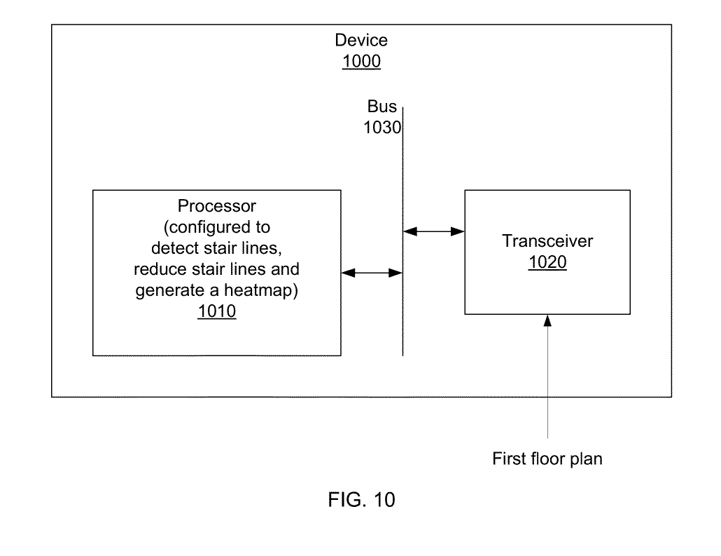

FIG. 10 shows a device 1000 for preparing a heatmap, in accordance with some embodiments. The device 1000 may be a location server, another separate server or a mobile device 210. The device 1000 includes a processor 1010 and a transceiver 1020 coupled directly together and/or via a bus 1030.

The processor 1010 may be a general purpose processor, a special purpose processor, an ASIC, DSP, FPGA or the like. The processor 1010 may include internal memory and/or external memory. The memory may include software modules for execution in the processor 1010. For example, the memory may contain a staircase detection module, which acts as a means for detecting stair lines in the first floor plan. A staircase 100 may be detected explicitly (search for staircases in the first floor plan) or inherently (using dilation techniques discussed below). The memory may also contain a staircase reduction module, which acts as a means for reducing, leaving or replacing the stair lines in the first floor plan with no stair lines, a single stair line or a few stair lines (e.g., zero, one, two or three stair lines) in the second floor plan. The memory may also contain a heatmap generation module, which acts as a means for generating a heatmap from the second floor map. Alternatively, the processor 1010 executes code to detect a staircase, reduce stairs and generate a heatmap. The processor 1010 may act as a means to detecting, reducing and generating described above. The transceiver 1020 acts as a means for receiving a first floor plan and as a means for transmitting a heat map.

The transceiver 1020 receives a first floor plan and the processor 1010 detects each staircase 100 in the first floor plan. Once any staircases are identified, the processor 1010 reduces step lines (which may be interpreted as parallel walls in the prior art) to zero to three lines representing no walls to three walls, respectfully, to form a second floor plan. For example, any staircases going up may be replaced by removing all stair lines (e.g., thereby representing open space 300) and any staircases going down may be replaced with one stair line (e.g., single step 400 thereby representing a single wall).

The processor 1010 receives the second floor plan and generates a heatmap based on the second floor plan. The transceiver 1020 includes a receiver to receive the first floor plan and a transmitter to transmit the heatmap. The heatmap may be saved locally, to a separate location server or sent directly to a mobile device 210.

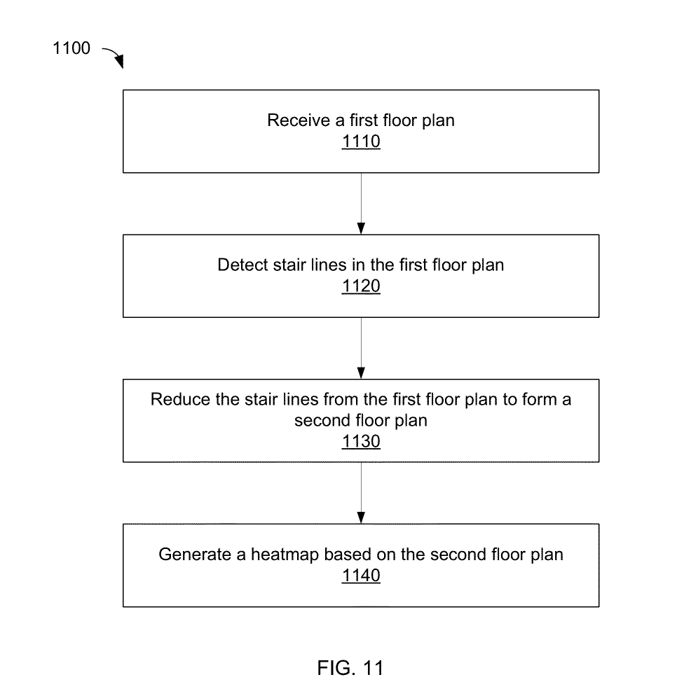

FIG. 11 illustrates a method 1100 for preparing a heatmap, in accordance with some embodiments. At 1110, a device 1000 receives a first floor plan (floor plan A). At 1120, the device 1000 detects stair line in the first floor plan (floor plan A). At 1130, the device 1000 reduces the stair lines from the first floor plan (floor plan A) to form a second floor plan (floor plan B). The reduced stair lines may eliminate stair lines otherwise interpreted as walls. The reduced stair lines may eliminate all stair lines or may replace of all but one stair line, two stair lines or three stair lines representing. For example, a descending staircase may be replaced with an open space 300 and an ascending staircase may be replaced with a single line or single step 400 representing attenuation of a single wall. If a floor plan does not indicate whether the staircase is descending or ascending, the staircase may be replaced with a single line as a compromise. Each remaining stair line in the altered or second floor map may be interpreted as a separate wall providing a curtain amount of attenuation. At 1140, the device 1000 generates a heatmap based on the second floor plan.

In some embodiments, morphological operation is used to reduce staircase lines. Since a staircase is often depicted as multiple closely placed parallel lines, using morphological operation, such as line dilation and shrinking techniques (also referred to as line dilation and erosion techniques), the parallel line can be merged into a single line or a rectangle without affecting other building structures, which are generally placed on a floor plan farther apart.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method in a device for generating a heatmap, the method comprising:
receiving a first floor plan;
detecting stair lines in the first floor plan;
reducing the stair lines from the first floor plan to form a second floor plan; and
generating the heatmap based on the second floor plan.

2. The method of claim 1, wherein reducing the stair lines from the first floor plan comprises removing all stair lines for a particular set of stairs.

3. The method of claim 2, wherein the stair lines represent a staircase descending from the first floor plan.

4. The method of claim 1, wherein reducing the stair lines from the first floor plan comprises replacing the stair lines in the first floor plan with a single line in the second floor plan.

5. The method of claim 4, wherein the stair lines represent a staircase ascending from the first floor plan.

6. The method of claim 1, wherein reducing the stair lines from the first floor plan comprises replacing the stair lines with two lines in the second floor plan.

7. The method of claim 1, further comprising sending the heatmap to a mobile device for positioning.

8. A device for generating a heatmap, the device comprising:
a transceiver configured to receive a first floor plan; and
a processor coupled to the transceiver, wherein the processor is configured to:
detect stair lines in the first floor plan;
reduce the stair lines in the first floor plan to form a second floor plan; and
generate the heatmap from the second floor plan.

9. The device of claim 8, wherein the processor configured to reduce the stair lines is configured to remove all stair lines for a particular set of stairs.

10. The device of claim 9, wherein the stair lines represent a staircase descending from the first floor plan.

11. The device of claim 8, wherein the processor configured to reduce the stair lines is configured to replace the stair lines in the first floor plan with a single line in the second floor plan.

12. The device of claim 11, wherein the stair lines represent a staircase ascending from the first floor plan.

13. The device of claim 8, wherein the processor configured to reduce the stair lines is configured to replace the stair lines from the first floor plan with two lines to represent two walls.

14. The device of claim 8, wherein the transceiver is further configured to send the second floor plan to a mobile device.

15. A device for generating a heatmap, the device comprising:
means for receiving a first floor plan;
means for detecting stair lines in the first floor plan;
means for reducing the stair lines from the first floor plan to form a second floor plan; and
means for generating the heatmap based on the second floor plan.

16. The device of claim 15, wherein the means for reducing the stair lines from the first floor plan comprises means for leaving no stair lines to represent a hallway in the second floor plan.

17. The device of claim 16, wherein the stair lines represent a staircase descending from the first floor plan.

18. The device of claim 15, wherein the means for reducing the stair lines from the first floor plan comprises means for replacing the stair lines with a single line representing a single wall.

19. The device of claim 18, wherein the stair lines represent a staircase ascending from the first floor plan.

20. The device of claim 15, wherein the means for reducing the stair lines from the first floor plan comprises means for replacing the stair lines with two lines to represent two walls.
